(19) United States
(12) Patent Application Publication
(10) Pub. No.: US 2003/0094781 A1
(43) Pub. Date: May 22, 2003

(54) Retractable step for vehicles and other purposes

(76) Inventors: Alfonso Jaramillo, Lake Matthews, CA (US); Suzanna Jaramillo-Curi, Anaheim, CA (US)

Correspondence Address: LAW OFFICES OF DAVID L. HOFFMAN, SUITE 422, 27023 McBEAN PARKWAY, VALENCIA, CA, 91355, US

(21) Appl. No.: 10/280,715

(22) Filed: Oct. 25, 2002

Related U.S. Application Data
(60) Provisional application No. 60/348,388, filed on Oct. 26, 2001.

(51) Int. Cl. B60R 3/00

(52) U.S. Cl. 280/166

(57) ABSTRACT

A retractable step assembly has a U-shaped step and two brackets, each bracket having a mounting face where it may be fixed to a vehicle and having a pair of bearing openings for rotatably supporting a first tube. The first tube has a torsion spring disposed therein. The first tube is fixed inside a second tube which is unitary or integral with a side arm of the U-shaped step. The bearing openings are preferably unitarily formed in the bracket. In another embodiment, the tubes are replaced by a pin fixed to the bracket. The pin has a torsion spring disposed around it. Each side arm of the U-shaped step has an annular bearing surface or opening for rotatably fitting around the pin. The annular bearing opening is preferably unitarily formed in the side arm of the U-shaped step. In a third embodiment, each bracket has the opposite ends of the same elongate pin fixed thereto. The elongate pin has two torsion springs disposed around it. One spring is proximate one side arm of the step and the other spring is proximate the other side arm. Each side arm has an annular bearing surface for rotatably fitting around the pin. In a fourth embodiment, there are two springs at each of the two brackets.

### CROSS-REFERENCE TO RELATED APPLICATION(S)

This application is related to U.S. Provisional Patent Application Serial No. 60/348,388, filed Oct. 26, 2001, the priority of which is claimed and which is incorporated herein by reference.

### BACKGROUND OF THE INVENTION

The present invention relates to a retractable step for vehicles and other purposes.

In watercraft such as personal watercraft and boats, it is desirable to have an outboard step, which assists a user in boarding a personal watercraft or boat, e.g., from the water after falling off, swimming or water skiing. In U.S. Pat. No. 5,152,244, a retractable stirrup having a U-shape is disclosed which pivotably mounts at its ends by means of two brackets to the transom of a personal watercraft. A torsion spring has one end acting on the bracket and another end acting on the end of the U-shaped step. The joint is made by using a cylindrical sleeve fixedly mounted to the bracket and the spring is disposed over the sleeve. The end of the spring acting on the bracket is disposed in a slot formed in the sleeve. The end of the U-shaped member is pivotably connected to the sleeve by passing the sleeve through the tube.

In U.S. Pat. No. 5,458,080, a retractable step assembly for a boat is disclosed. The assembly is formed by providing tubes disposed at the ends of a U-shaped retractable step, which tubes mate in a male-female fashion with tubes which are part of a mounting assembly. The tubes connected to the step are rotatable with respect to the tubes of the mounting assembly. A torsion spring is provided at the joint formed by the male-female connection and has one end acting on the retractable step and the other end acting on the mounting assembly. This disclosed embodiment provides limited space for a spring, as does the previously-mentioned U.S. Pat. No. 5,152,244.

Step-mounting assemblies to provide more space for a spring to obtain greater bias strength, and greater support for vertical and lateral forces and to enable the use of heavier materials, such as stainless steel rather than aluminum have been developed. A variety of such assemblies are shown in U.S. Pat. Nos. 5,927,433, 6,021,733, and 5,970,905, all also to the present inventor. Stainless steel is more durable, stronger and less subject to corrosion in a water or saltwater environment.

While some or all of these steps may be used on vehicles and in environments other than boats and personal watercraft, these steps could be made even stronger, more economically, and simpler. In addition, there are additional aspects of the steps that can be modified to make the steps more suitable for a vehicle or other application.

### SUMMARY OF THE INVENTION

In one embodiment, the present invention provides a retractable step for a vehicle. A retractable step assembly has a U-shaped step and two brackets. Each bracket has a mounting face where it may be fixed to a vehicle and also has a pair of annular bearing openings for rotatably supporting a first tube. The first tube has a torsion spring disposed therein and is fixed inside a second tube. The second tube is unitary or integral with a side arm of the U-shaped step. The bearing openings are preferably unitarily formed in the bracket. The step may be used on trucks, recreational vehicles, vans, and sport utility vehicles, for the driver and/or passenger doors or for access to the rear. It may also be used for other applications, such as bunk beds, attics, and boats.

In another embodiment, a retractable step assembly has a U-shaped step and two brackets. Each bracket has a mounting face where it may be fixed to a vehicle. Each bracket also forms a channel and a pin is fixed to the bracket and disposed in the channel. The pin need not be fixed against rotation, but preferably is. If the pin is not fixed against rotation, openings in the bracket rotatably support the pin. The pin has a torsion spring disposed around it. Each side arm of the U-shaped step has an annular bearing surface for rotatably fitting around the pin. The bearing surface is an annular opening, i.e., it is preferably unitarily formed in the side arm of the U-shaped step.

In a third embodiment, the retractable step assembly has a U-shaped step and two brackets. Each bracket has a mounting face where it may be fixed to a vehicle. Each bracket also has an inner face to which a single elongated tube or pin is fixed. That is, the pin extends between each side arm of the step. The pin may alternatively be disposed in holes formed in each bracket and may be rotatable with respect to the bracket. The step has two torsion springs disposed around it, one proximate each side arm. Each side arm has an annular bearing surface for rotatably fitting around the pin. The annular bearing surface is preferably unitarily formed in the side arm of the U-shaped step. The free end of each side arm may have a reinforcing bar extending between the two arms and fixed thereto.

In a fourth embodiment, the retractable step assembly has a u-shaped step and two brackets. Each bracket has a mounting face where it may be fixed to a vehicle. Each bracket also has two sides or flanges, with a cylinder attached between the sides. Each end of the arms of the u-shaped step attach to the mid point of each cylinder. Two coil springs are disposed inside the cylinder, one on each side of the mid point. Each coil spring has an end attached to the cylinder and an end attached to the side of the bracket. The springs bias the step so as to rotate upward with respect to the vehicle to which the step is mounted. Operation of this embodiment is similar to the previous embodiments.

### BRIEF DESCRIPTION OF THE DRAWINGS

FIG. 1 is a perspective view of retractable step for a vehicle in accordance with a first embodiment of the invention;

FIG. 2 is an enlarged exploded view of one bracket and a portion of a side arm of the step of FIG. 1;

FIG. 3 is a perspective view of the step of FIG. 1 attached to a vehicle, namely a truck chassis;

FIG. 4 is a perspective view of retractable step for a vehicle in accordance with a second embodiment of the invention;

FIG. 5. is an enlarged exploded view of one bracket and a portion of a side arm of the step of FIG. 4;

FIG. 6 is a perspective view of the step of FIG. 4 attached to a vehicle, namely a truck chassis;

FIG. 7 is a perspective view of retractable step for a vehicle in accordance with a third embodiment of the invention;

FIG. 8 is a perspective view of the step of FIG. 7 attached to a vehicle, namely a truck chassis;

FIG. 9 is a perspective view of a retractable step for a vehicle in accordance with a fourth embodiment of the invention;

FIG. 10 is an enlarged exploded view of one bracket and a portion of a side arm of the step of FIG. 9;

FIG. 11 is a perspective view of the inside of a bracket of FIG. 9; and

FIG. 12 is a perspective view showing the step of FIG. 9 mounted on a vehicle.

### DETAILED DESCRIPTION OF THE PREFERRED EMBODIMENTS

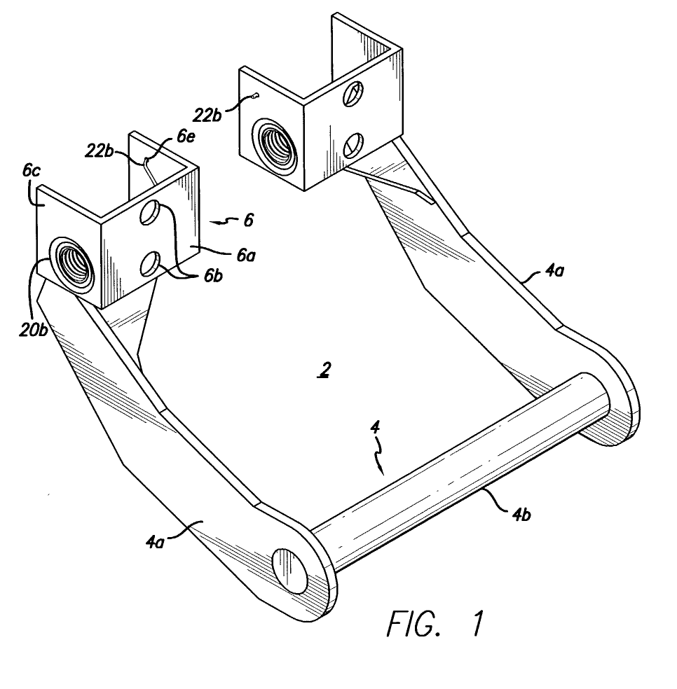

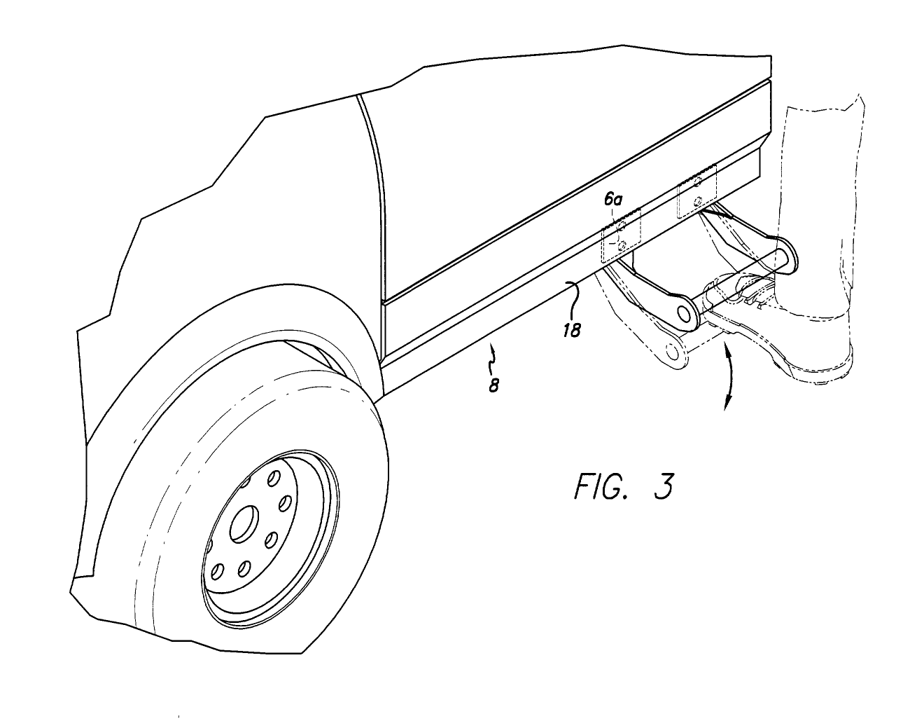

A retractable step for a vehicle in accordance with a first embodiment of the invention will be described with respect to FIGS. 1-3. A retractable step assembly 2 has a U-shaped step 4 and two brackets 6. Each bracket has a mounting face 6a where it may be fixed to a vehicle 8. The mounting face has holes 6b through which bolts may pass. Nuts may be used to secure the bolts and step assembly to the vehicle. In this embodiment, it is secured to an inner face of a vertical portion 18 of the door frame or chassis. The bracket has two sides 6c, each of which has an annular bearing ring 6d for rotatably supporting a first tube 20. First tube 20 has a torsion spring 22 disposed therein and is fixed inside a second tube 24, e.g., by welding. Second tube 24 is preferably unitary or integral with a side arm 4a of the U-shaped step 4. A bar 4b forms the actual stepping area.

First tube 20 has a slot 20c into which a first end 22a of spring 22 fits. The other end 22b fits into a hole 6e in a side 6c of the bracket. The ends 22a and 22b need only be mechanically secured in the slot and hole, respectively, so as stay therein during rest and use of the step. The first tube 20 has two ends 20a, 20b, which fit rotatably in the annular bearing rings or surfaces 6d. The ends 20a, 20b may be flared or swaged circumferentially outward, so that the first tube will stay in the bearing surfaces 6d.

The bearing surfaces or openings 6d are preferably unitarily formed in bracket 6. The step assembly 2 may be used on trucks, recreational vehicles, vans, and sport utility vehicles, for the driver and/or passenger doors or for access to the rear. It may also be used for other applications, such as bunk beds, attics, and boats.

The step components may be made of stainless steel, aluminum, or other suitable materials.

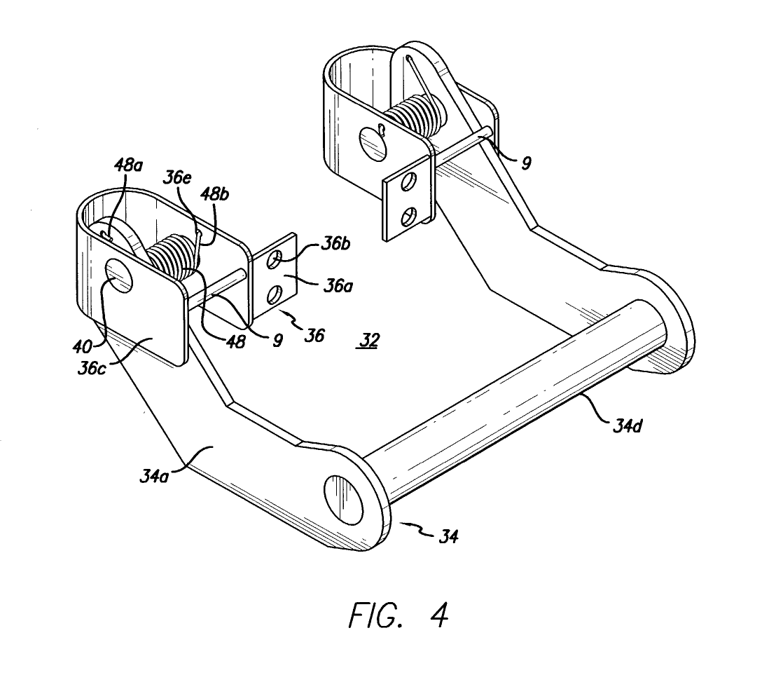

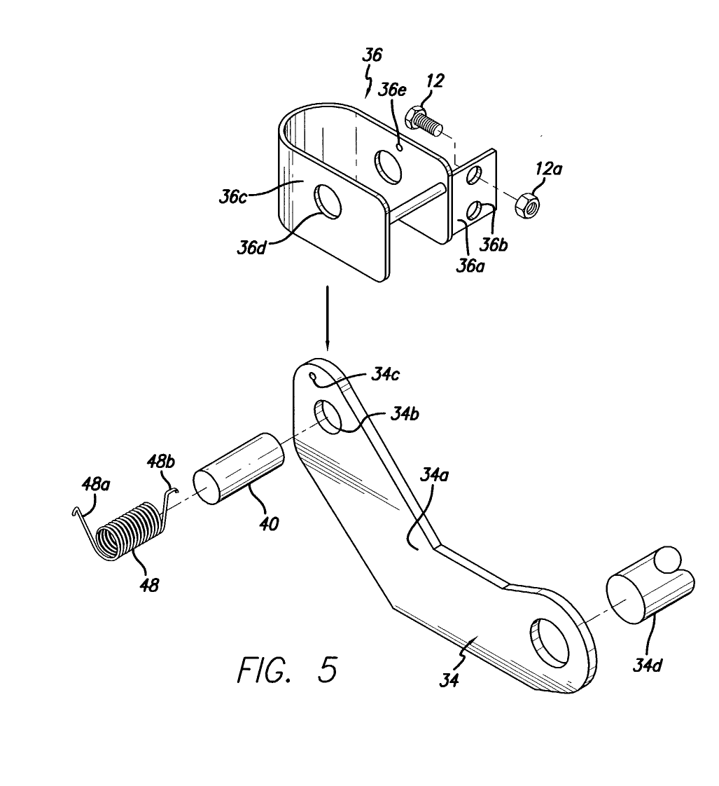

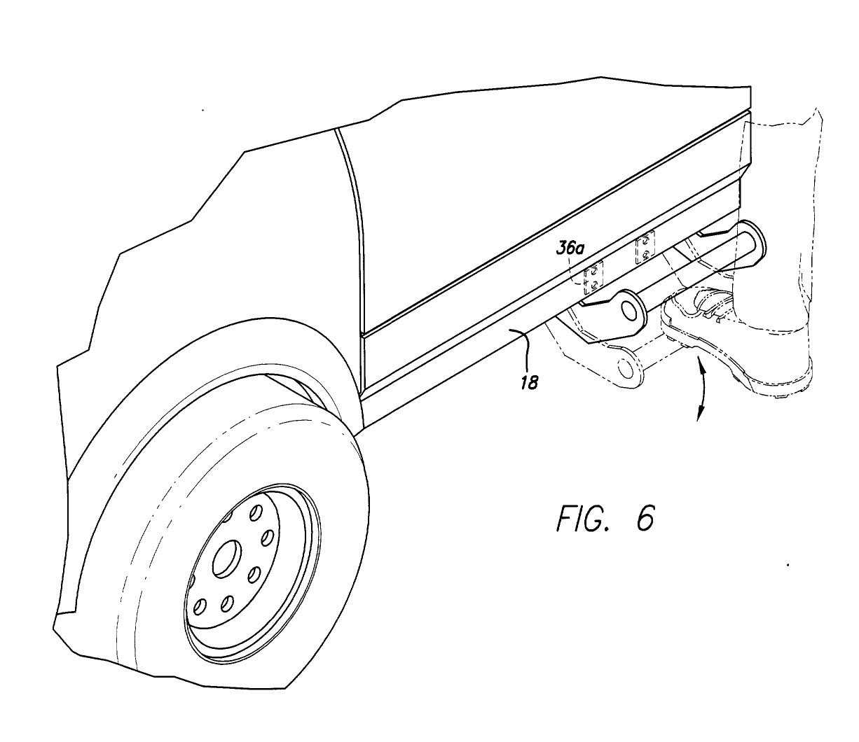

In another embodiment shown in FIGS. 4-6, a retractable step assembly 32 has a U-shaped step 34 having a stepping bar 34d and two brackets 36. Each bracket has a mounting face 36a where it may be fixed to a vehicle. The mounting face has holes 36b through which bolts 12 may pass. Nuts 12a may be used to secure the step assembly to the vehicle. FIG. 5 shows one bolt and nut as an example, but there would be a nut and bolt for each bolt hole 36b. The same nuts and bolts would be used in the other embodiments.

In this embodiment, it is secured to an inner face of a vertical portion 18 of the door frame or chassis. Each bracket also has two sides 36c, which form a channel. A pin 40 is fixed to the bracket, e.g., by welding, and disposed in the channel. Preferably, the pin is vertically and laterally supported in two large annular holes 36d formed in the sides 36c of the bracket and fixed therein, e.g., by welding. However, the pin 40 need not be fixed against rotation, but preferably is. Alternatively, the pin is simply free in the annular holes, but should be swaged or widened at its ends so that it will stay in the holes. The pin has a torsion spring disposed around it. Each side arm 34a of the U-shaped step has an annular bearing surface 34b (a large hole) for rotatably fitting around the pin. A torsion spring 48 fits around pin 40. One end 48a of the spring fits through a hole small 34c in the side arm 34a and the other end 48b fits through a small hole 36e in the bracket.

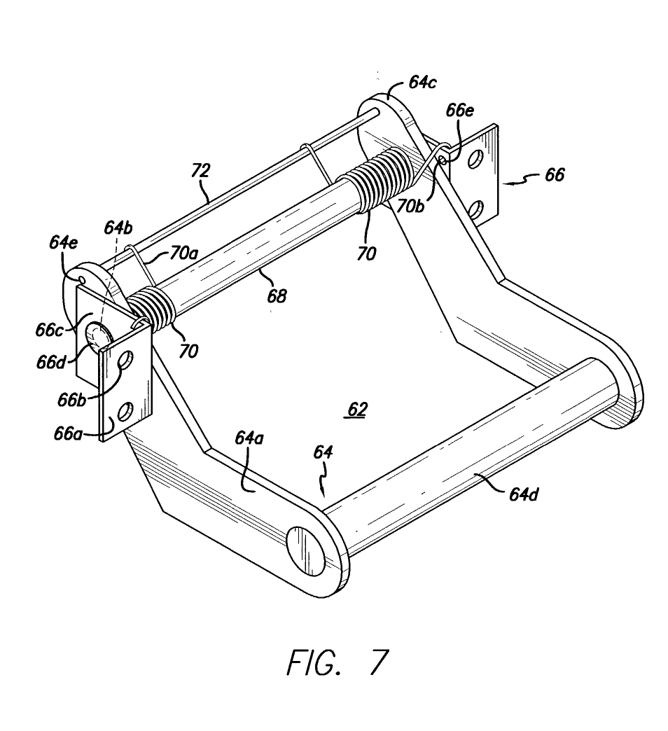

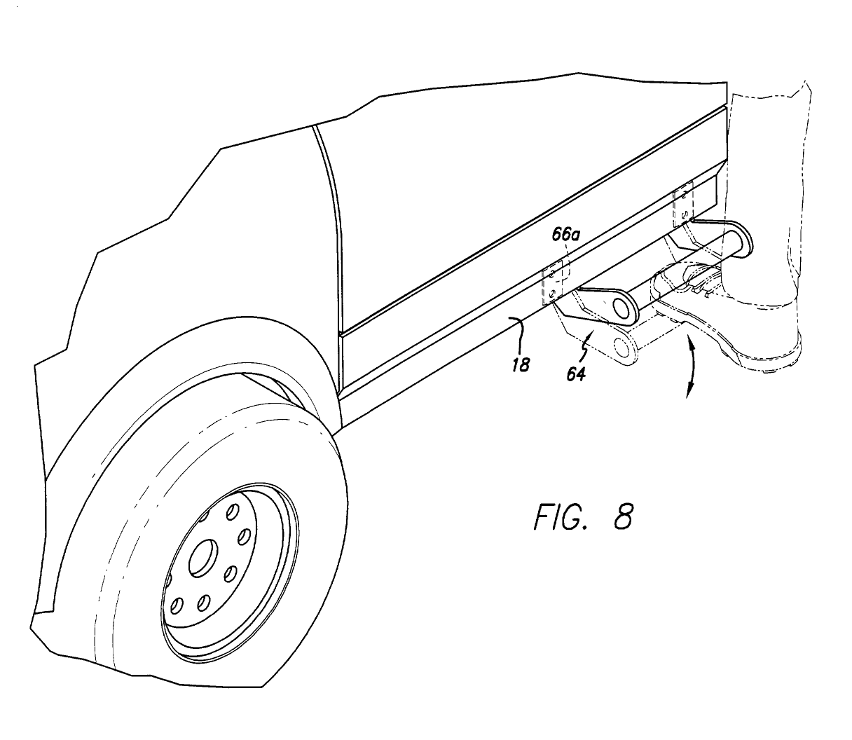

In a third embodiment shown in FIGS. 7-8, a retractable step assembly 62 has a U-shaped step 64 having a stepping bar 64d and two brackets 66. Each bracket has a mounting face 66a where it may be fixed to a vehicle. The face 66a has bolt holes 66b. Each bracket also has an inner face 66c to which a single elongated tube or bar 68 is fixed. That is, bar 68 extends between each side arm 64a of the step. The bar is preferably disposed in holes 66d formed in each bracket, and preferably fixed therein, e.g., by welding. Alternatively, the bar is simply free in the annular holes, but should be swaged or widened at its ends so that it will stay in the holes.

The bar has two torsion springs 70 disposed around it, one proximate each side arm 64a. Each side arm 64a has an annular bearing surface 64b through which the bar 68 rotatably fits. The annular bearing surfaces 64b are preferably unitarily formed in the side arm of the U-shaped step. The free end 64c of each side arm may have a reinforcing bar 72 extending between the two arms and fixed thereto. The bar 72 may be supported in holes 64e formed in the side arms 64a of the step and welded therein. One end 70a of each torsion spring 70 may be hooked onto or wrapped around the bar 72 and the other end 70b may fit through a hole 66e in each bracket 66. The springs 70 bias the step to rotate counterclockwise in FIGS. 7 and 8 to move stepping bar 64d upward.

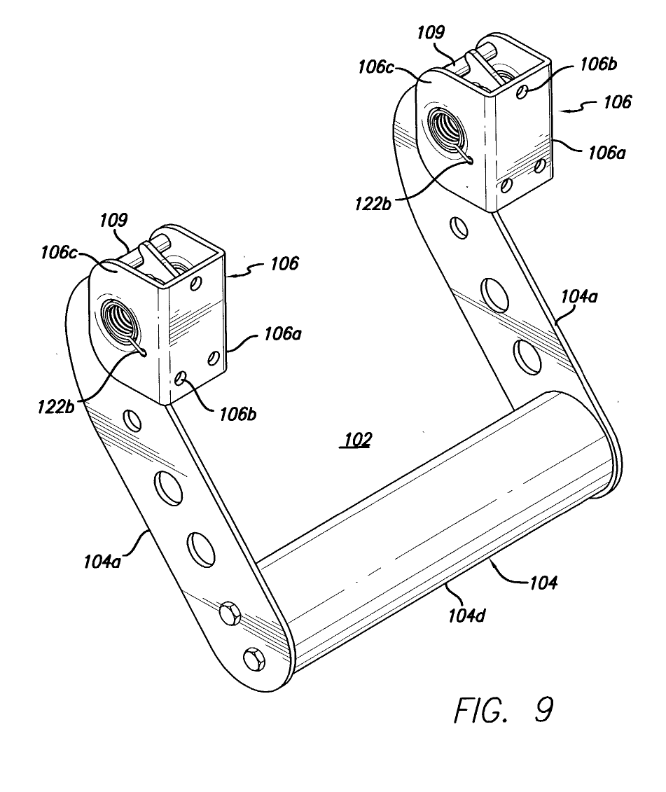

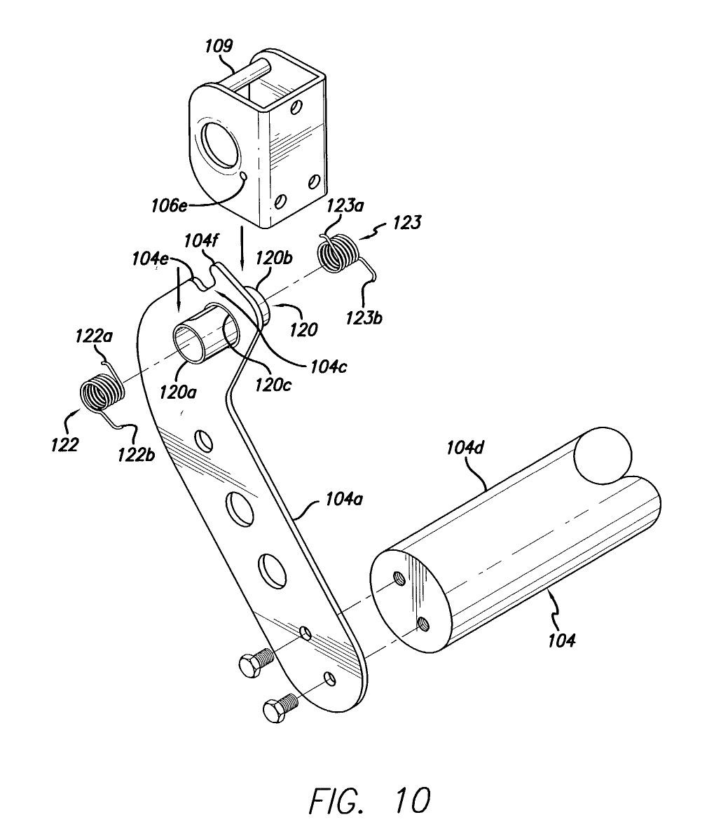

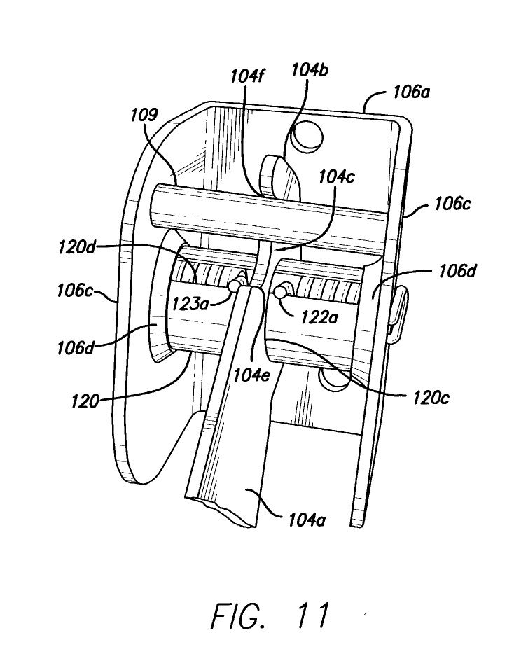

In a fourth embodiment shown in FIGS. 9-12, a retractable step assembly 102 has a U-shaped step 104 having a stepping bar 104d and two brackets 106. A mounting face 106a of each bracket has bolt holes 106b where the bracket may be fixed to a vehicle chassis or door frame as in other embodiments. Each arm 104a is welded or otherwise fixed to a cylinder 120 extending between the inner faces of brackets 106. The weld of the cylinder 120 is preferably at the midpoint 120c of the cylinder. The arm 104a may be may be fixed by other means to cylinder 120.

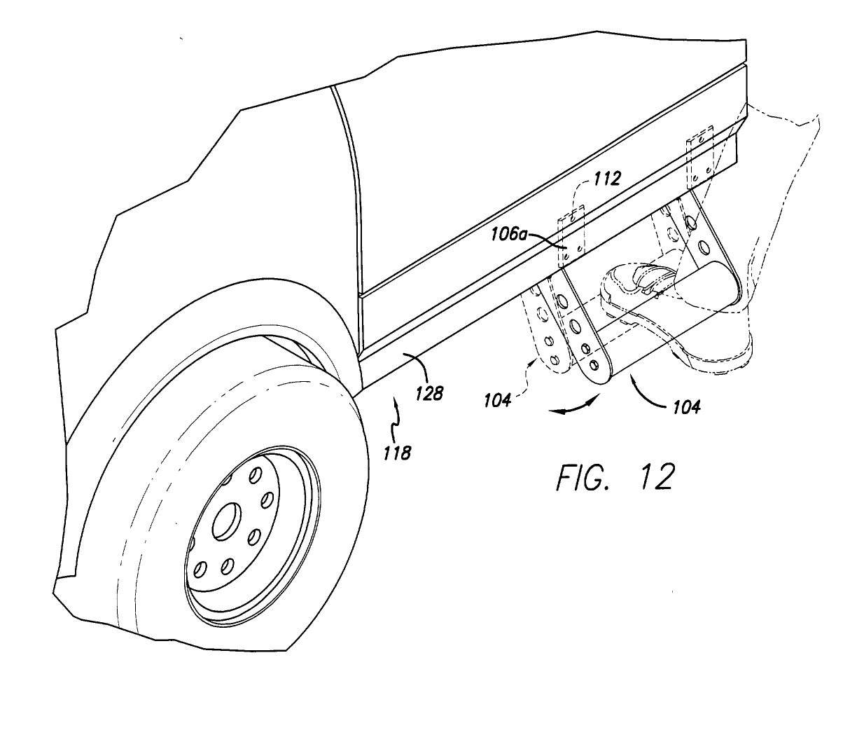

Two coil springs 122, 123 are located inside cylinder 120. One spring 122 is located on the left and the other spring 123 is located on the right. Each spring has a first end 122a, 123a, respectively, both of which fit through a slot 120d in the cylinder 120. Preferably, these ends are bent to engage the cylinder. The other ends 122b, 123b, respectively, engage holes 106e in the brackets 106. The torsion springs 122, 123 bias the cylinder to rotate counterclockwise (upward), e.g., in FIG. 12. The cylinder, and each end 120a, 120b are supported by annular flanges 106d in the sides 106c of each mounting bracket. The cylinder is shown with its ends located inside the flanges, but it could also be located around the flanges. Either way, the cylinder is rotatable with respect to the flanges 106d.

The bias of the springs 122, 123 urges step assembly 104 into an upper, rest or storage position, which is shown in solid lines in FIG. 12. Step assembly 104, in FIG. 12 is shown mounted to the inside of the truck chassis by means of mounting face 106a using nuts and bolts. Mounting is preferably at chassis 128 of truck 118 immediately below a door.

With the step in the upper or rest position, a user lifts his or her foot to step on the step assembly 104 at cross member 104d. The weight of the user causes the step to rotate downward and inward with respect to the truck body. When the assembly rotates downward and inward, it will be stopped by the inner edge 104e of notch 104c in arm 104a contacting reinforcing bar 109. Alternatively, as in other embodiments, the end 104b of the arm 104a could contact the inner face of mounting bracket 106 to act as a stopper.

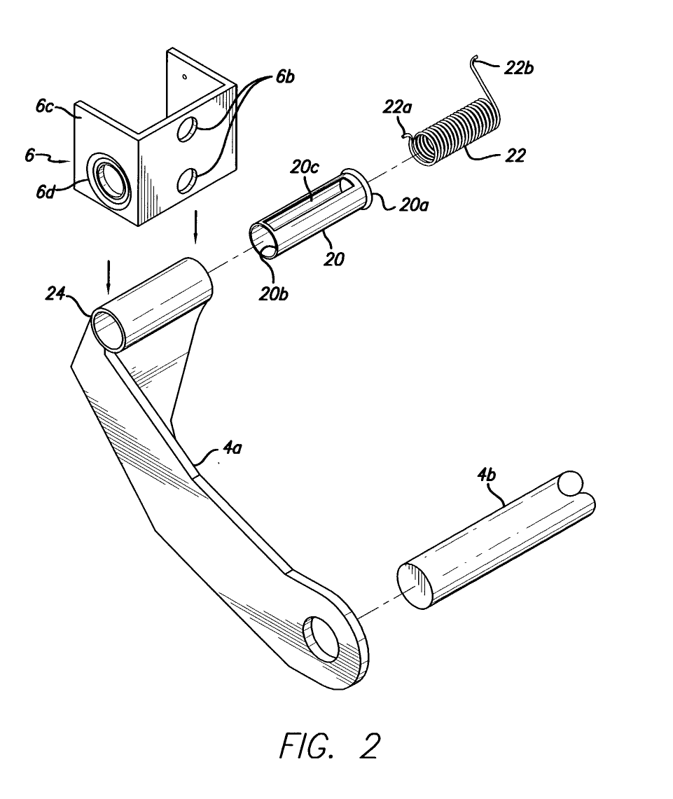

In use, in each embodiment, the U-shaped step arm is located in the solid position shown in FIGS. 2, 5, 8 and 12. When the user steps on the step, e.g., 4b in the first embodiment shown in FIG. 2, the step arms rotate downward against the torsional force of the spring to the use position shown in phantom. The amount of rotation is preferably limited by the geometry of the bracket, e.g., by the step arm colliding with the bracket itself or a stopper pin on the bracket. Such a stopper pin is preferably simply a metal rod or pin extending between the bracket sides and fixed thereto to limit rotation of the side arm to the point where it collides with the pin. One such exemplary stopper pin 9 is shown in FIGS. 4-5 for limiting the upward rotation of the step so that it does not collide with the underside of the truck or vehicle. Alternatively, the truck itself or vehicle itself could be used as a stopper. A stopper for downward rotation is not always necessary, but is useful. In some or all of the disclosed embodiments, the bracket itself functions as a stopper on downward and/or upward rotation.

In the embodiments such as those for a truck or other land vehicle, typically the amount of rotation of the step should be less than about forty five (45) degrees (though not required) so that the step will not be under the vehicle footprint when in the use position. The steps of the above embodiments are shown with bent side arms to assist in mounting the brackets to the inner face of the door frame or chassis. The bend enables the step itself to be located outward of the vehicle and sufficiently high in the rest position to provide desirable ground clearance.

While the present invention has been described with regards to particular embodiments, it is recognized that additional variations of the present invention may be devised without departing from the inventive concept.

What is claimed is:

1. A step assembly, comprising:
a U-shaped step having first and second sides; and
a support assembly comprising means for mounting the step, each means for mounting comprising a bracket, a spring, and an elongate member, the elongate member being rotatably mounted to the bracket, the bracket having means for defining annular holes formed in the bracket for rotatably supporting the elongate member, and the first and second sides having holes formed therein for receiving the elongate member, the sides being rotatably mounted to the elongate member, and each spring being adapted for biasing the step to a first rotational position with respect to each bracket for storage, and the step being rotatable to a second rotational position with respect to each bracket during use, in response to a user putting weight on the step against the bias of the spring.

2. The step assembly of claim 1 wherein there are two means for mounting, and the elongate member comprises one rod extending from one bracket to the other.

3. The step assembly of claim 1 wherein there are two means for mounting, and the means for defining formed in each bracket has two annular bearing surfaces unitarily formed therewith, and there are two elongate members, each elongate member having its ends supported in the annular bearing surfaces of each bracket, respectively.

4. The step assembly of claim 3 wherein each elongate member is fixed to the brackets.

5. The step assembly of claim 1 wherein the means for defining holes in the first and second sides comprise tubes integrally attached to the sides.

6. The step assembly of claim 2 wherein each spring is disposed around the bar.

7. A step assembly, comprising:
a U-shaped step having first and second sides; and
a support assembly comprising means for mounting the step, each means for mounting comprising a bracket, a pair of springs, and an elongate member, the elongate member being rotatably mounted to the bracket, the bracket having means for defining annular holes therein for rotatably supporting the elongate member, and the first and second sides each having a hole formed therein the elongate member, the sides being fixedly mounted to the elongate member, and each pair of springs being adapted for biasing the step to a first rotational position with respect to each bracket for storage, and the step being rotatable to a second rotational position with respect to each bracket during use, in response to a user putting weight on the step against the bias of the spring.

8. The step assembly of claim 7 wherein the elongate member comprises a tube having a longitudinal slot formed therein for receiving a first end of each spring in each said pair of springs, and a second end of each spring being engaged with said bracket.

9. The step assembly of claim 7 wherein there are two means for mounting, and the means for defining formed in each bracket has two annular bearing surfaces unitarily formed therewith, and there are two elongate members, each elongate member having its ends supported in the annular bearing surfaces of each bracket, respectively.

10. The step assembly of claim 7 wherein each bracket has a reinforcing bar fixed thereto.

11. The step assembly of claim 10 wherein an end of the first and second sides has a notch formed therein in which the reinforcing bar is disposed.

12. The step assembly of claim 7 wherein each spring is disposed in the tube.

13. The step assembly of claim 11 wherein one part of the sides where the notch is formed comprises a first stopper surface for engaging the reinforcing bar at a limit of rotation in one direction, and another part of the sides where the notch is formed comprises a second stopper surface for engaging the reinforcing bar at a limit of rotation in another direction.
